(19) United States
(12) Patent Application Publication
(10) Pub. No.: US 2019/0137115 A1
(43) Pub. Date: May 9, 2019

(54) EMBEDDED CARBON VEIL HEATING SYSTEMS AND INSTALLATION METHODS

(71) Applicant: LAMINAHEAT HOLDING LTD., CO. KILDARE (IE)

(72) Inventor: PETER SAJIC, DORSET (GB)

(21) Appl. No.: 16/220,998

(22) Filed: Dec. 14, 2018

Related U.S. Application Data
(63) Continuation of application No. PCT/EP2018/079892, filed on Oct. 31, 2018.
Application No. PCT/EP2018/079892 is a continuation-in-part of application No. PCT/IB2017/000870, filed on Jun. 14, 2017.
(60) Provisional application No. 62/579,472, filed on Oct. 31, 2017.
(60) Provisional application No. 62/349,858, filed on Jun. 14, 2016.

(51) Int. Cl. F24D 13/02; H05B 1/02; H05B 3/06; H05B 3/14; H05B 3/18; H05B 3/28; E04F 15/16; E04F 13/00; B32B 5/02; B32B 7/12; B32B 27/30; B32B 9/04; B32B 9/00

(52) U.S. Cl. CPC F24D 13/024; B32B 2419/00; H05B 3/06; H05B 3/145; H05B 3/18; H05B 3/286; E04F 15/163; E04F 13/002; B32B 5/022; B32B 7/12; B32B 27/304; B32B 9/045; B32B 9/007; H05B 2203/016; H05B 2203/032; H05B 2203/033; H05B 1/0275

(57) ABSTRACT

A heating system including a carbon veil heating element having at least two busbars embedded between opposite layers of insulating film, a connector busbar assembly having at least two connector electrical busbars and a matrix of insulation connecting them, penetrating conductive fasteners configured to protrude through the respective busbars of the heating element and the connector busbar assembly, and a controller configured to connect to the connector busbars and apply electrical current sufficient to cause the heating element to produce heat between the veil busbars. The busbars preferably have a width to thickness ratio greater than 10, more preferably greater than 100. Methods for installing the heating system are also described.

This application claims priority from PCT Application Ser. No. PCT/EP2018/079892, filed 31 Oct. 2018, which claims priority from U.S. Provisional Application No. 62/579,472, filed on 31 Oct. 2017, both titled “THIN-PROFILE BUSBAR ASSEMBLIES AND HEATING SYSTEMS ELECTRICALLY CONNECTED THEREWITH,” and is a continuation-in-part of PCT Application No. PCT/IB2017/000870, filed on 14 Jun. 2017, which claims priority from U.S. Provisional Application No. 62/349,858, filed on 14 Jun. 2016, both titled “PRODUCTS WITH EMBEDDED CARBON VEIL HEATING ELEMENTS.” The contents of all of foregoing are incorporated herein by reference in their entireties.

### FIELD OF THE INVENTION

The present invention relates to heating systems, and more specifically, to systems for heating surfaces, such as floors, walls, and ceilings, or for being embedded in thin multilayer structures, and busbar assemblies for use in installation of such heating systems.

### BACKGROUND

Conventionally, floor-heating products consist of either bulky electrical wires (which provide resistive heating) or bulky liquid tubes (which provide hydronic heating) installed between the floor and the sub-floor. Installation of a heated floor thus required the homeowner to install either the bulky electrical wires or liquid tubes directly onto the sub-floor, with the flooring material (e.g. tile, hardwood, etc.) installed on top of the electrical wires or liquid tubes.

This process is time consuming, labor intensive and expensive. In addition, the heating elements (i.e. the wires or tubes) are placed well below the floor surface, due to the thickness of the flooring itself. As a result, the heat produced by the wires or the liquid filled tubes takes a long time to heat the actual walking surface of the floor. Therefore, this process is not energy efficient and creates a long lag time between activating the heater and the flooring actually reaching the desired temperature.

### SUMMARY

One aspect of the invention comprises, a busbar assembly, comprising at least two busbars, each busbar comprising a conductive metal preferably having a rectangular cross section having a ratio of width to thickness greater than 10, and a matrix of insulation connecting the at least two busbars together. The ratio of width to thickness may be greater than 13.3, or in thin-profile embodiments, greater than 100, preferably in a range of 100-700, and more preferably in a range of 150-600. The conductive metal may comprise copper and the matrix of insulation may comprises PVC. The conductive metal may have a thickness T in a range of 50 micron to 200 microns, and a width W in a range of 10-80 mm, and may be sandwiched between opposing sheets of insulating film having a thickness in a range of 50-200 microns. The insulating film and the conductive metal may be laminated together. At least one additional layer may be disposed over at least one of the opposing sheets of insulating film. The additional layer may comprise a non-woven scrim, comprising a material, such as PETV, for characteristically promoting bonding of the busbar assembly to plaster or cement. In another embodiment, the additional layer may comprise a contact adhesive, such as a contact adhesive covered by a removable covering.

Another aspect of the invention comprises a heating system comprising the busbar assembly described above as described herein, in particular a heating system disposed on or in a floor, wall, or ceiling. In one embodiment, the heating system may comprise at least one carbon veil heating element comprising at least two electrically conductive veil busbars spaced apart from one another, a connector busbar assembly comprising at least two connector electrical busbars connected to the at least two veil busbars, and a controller electrically connected to the connector busbars configured to apply electrical current to the connector busbars sufficient to cause the at least one carbon veil heating element to produce heat in a portion thereof located between the veil busbars. The connector busbar assembly comprises the connector electrical busbars and a matrix of insulation connecting the connector busbars together. The connector busbars comprising a conductive metal having a rectangular cross section with a width and a thickness in which a ratio of the width to the thickness is greater than 10. The carbon veil heating element may be disposed on or in a surface of a building, such as a floor, a wall, or a ceiling, and the connector busbar assembly may be disposed on or in the same surface as the heating element or on or in a surface different from but adjacent to the surface as the heating element. The connector electrical busbars may be connected to the veil busbars via one or more fasteners, each fastener protruding through and electrically connecting one electrical busbar in the connector busbar assembly to one electrical busbar in the heating element.

Another aspect of the invention comprises a method of installing any of the heating systems described herein, comprising disposing at least one carbon veil heating element on or in a floor, wall or ceiling, and connecting the at least one carbon veil heating element to the busbar assembly. One method for installing a heating system comprises the steps of (a) mounting at least one carbon veil heating element on or in a surface, the heating element comprising at least two electrically conductive veil busbars spaced apart from one another, (b) electrically connecting a connector busbar assembly to the veil busbars, and (c) electrically connecting the connector busbar assembly to a controller configured to apply electrical current to the connector busbar assembly sufficient to cause the at least one carbon veil heating element to produce heat in a portion thereof located between the veil busbars. The connector busbar assembly comprises at least two connector busbars and a matrix of insulation connecting the at least two connector busbars together, the connector busbars comprising a conductive metal having a rectangular cross section with a width and a thickness in which a ratio of the width to the thickness is greater than 10.

The method may further comprise covering the carbon veil heating element and the busbar assembly by plaster or cement, and disposing a covering over the plaster or cement. The step of connecting the carbon veil heating element to the busbar assembly may comprise penetrating the carbon veil heating element and the busbar assembly with a conductive fastener. The method may further comprise disposing a non-conductive covering, such as insulating tape or a polymeric or elastomeric sealant, over at least a portion of the conductive fastener disposed on and protruding from on an outermost surface of the connected heating element and busbar assembly.

In one embodiment, the connector busbars may comprise floor busbars that are recessed in a subfloor upon which a section of flooring is installed, or located behind a baseboard adjacent the section of flooring is installed. The floor busbars typically extend along a length of the section of flooring and are electrically connected to respective sets of veil busbars in the carbon veil heating element in a plurality of locations. The system may also comprise a temperature sensor positioned in a location operable to sense heat emitted from the section of flooring and in communication with the controller, wherein the controller is configured to apply electrical current to the busbars based upon an input signal from the temperature sensor. The flooring product may comprise visible indicia on a surface thereof aligned with each embedded busbar, such as temporary or removable marking or an element of a decorative pattern visible in a finished floor surface facing upward from the floor.

In one embodiment, at least two floor electrical busbars may be connected to and electrically isolated from one another by a matrix of insulation. At least a first length and a second length of continuous busbar track may comprise the at least two floor electrical busbars spaced apart from one another, each length having opposite ends, and one or more connectors configured to electrically connect at least a busbar from the first length to a respective busbar of the second length. Each of the at least two floor electrical busbars may protrude from the opposite ends of the busbar track, and the one or more connectors may comprise at least two annular busbar sheaths connected to and electrically isolated from one another by a matrix of insulation, each sheath internally dimensioned and positioned to mate with the protruding ends of respective busbars from adjoining lengths of busbar track. One or more fasteners may protrude through and electrically connect one busbar to one busbar sheath.

Still another aspect of the invention comprises a busbar track system for use in a heated floor system, the track system comprising at least two busbars, each busbar comprising a conductive metal having a rectangular cross section having a width and a thickness in which the width is greater than 10× the thickness, and a matrix of insulation connecting the at least two busbars together. Yet another aspect of the invention may comprise a busbar track connector for the busbar track system as described herein, the connector comprise at least two busbar sheaths, each busbar sheath comprising a annular conductive metal having a rectangular cross section internally dimensioned to receive one of the at least two busbars, and a matrix of insulation connecting the at least two busbar sheaths together.

Another aspect of the invention comprises a method for installing a heated floor system. The method comprises installing a section of flooring including an embedded carbon veil heating element onto an area of a floor, the carbon veil heating element comprising at least two electrically conductive veil busbars spaced apart from one another, installing at least two electrical floor busbars beneath the section of flooring or on a vertical surface adjacent to the floor, electrically connecting the electrical floor busbars to the veil busbars in the embedded carbon veil heating element, electrically connecting the electrical floor busbars to a controller configured to apply electrical current to the floor busbars sufficient to cause the carbon veil to produce heat in a portion thereof located between the veil busbars.

Still another aspect of the invention comprises a method of making a heated laminar product, the method comprising providing a roll of a carbon veil heating element having a width equivalent to a width of a desired finished roll of laminar product, the heating element having one or more pairs of veil busbars, feeding one end of the roll of the carbon veil heating element between respective ends of upper and lower layers of respective feedstocks of laminar intermediate material, and embedding the carbon veil heating element between the upper and lower layers to form the finished roll of laminar product, such that the carbon veil heating element is less than 1 mm from an upper surface of the laminar product. The laminar product may be, for example, a flooring product or a cover or tarp. In an embodiment in which the laminar product is a flooring product, the method may comprise laminating the roll of the carbon veil heating element between a top layer of flooring intermediate fed from a first roll and a bottom layer of flooring intermediate fed from a second roll. The first and second feedstocks may each be extruded. In an embodiment in which the laminar product is a floor underlayment, the first layer may comprise a film and the second layer may comprise a foam.

Yet another aspect of the invention comprises a carbon veil heating element feedstock comprising a carbon veil heating element having a plurality of pairs of electrically conductive veil busbars spaced apart from one another along a width of the feedstock and the feedstock configured as a spirally wound cylindrical roll along a length of the feedstock.

### BRIEF DESCRIPTION OF THE FIGURES

FIG. 1A shows a magnified image of the carbon fibers in an exemplary carbon veil heating element.

FIG. 1B depicts an exemplary carbon veil heating element.

FIG. 2 shows a cross sectional comparison view of a flooring product having both a carbon veil heating element and a conventional wire/pipe heating element.

FIG. 3 shows a cross sectional comparison view of a flooring product having a heating element installed below the floor and a carbon veil embedded just below the surface.

FIG. 4 shows an energy graph of the energy consumed by the embedded carbon veil vs. a base heater installed below the flooring.

FIG. 5 shows a block diagram of the control system for controlling the heated flooring product.

FIG. 6 shows a flowchart of the operation of the system in FIG. 5.

FIG. 7A shows a first exemplary installation of an exemplary heated flooring product in which the floor busbars are recessed in the subfloor.

FIG. 7B shows a first exemplary fastener system for connecting floor busbars to veil busbars.

FIG. 7C shows a second exemplary fastener system for connecting floor busbars to veil busbars.

FIG. 7D shows an exemplary pattern having visual indicia usable by an installer to determine the alignment of the veil busbars in an exemplary heated flooring product.

FIG. 8 shows a second exemplary installation of an exemplary heated flooring product in which the floor busbars are positioned on or in the wall, behind a baseboard.

FIG. 9 shows an exemplary system for manufacturing the heated flooring product.

FIG. 10A illustrates an exemplary busbar assembly for providing floor busbars.

FIG. 10B depicts a cross section of the exemplary busbar assembly of FIG. 10A.

FIG. 10C depicts a longitudinal section of two lengths of busbar assembly joined by an exemplary connector.

FIG. 10D depicts a longitudinal section of the exemplary connector of FIG. 10C.

FIG. 10E depicts a perspective view of the exemplary connector of FIG. 10D and portions of respective busbar to be connected.

FIG. 11 depicts an exemplary system for manufacturing an exemplary busbar assembly and connectors.

FIGS. 12A-12E depict an exemplary thin-profile busbar assembly.

### DETAILED DESCRIPTION

One aspect of the invention comprises a flooring product comprising an embedded electrically conductive nonwoven carbon veil. The carbon veil is constructed of electrically conductive material, such as discontinuous nonwoven carbon fiber, such as is described in PCT/IB2016/000095, incorporated herein by reference. Generally, the carbon veil may be formed by wet laid manufacturing methods from conductive fibers (specifically carbon), non-conductive fibers (glass, etc.), one or more binder polymers and optional flame-retardants. Preferred lengths of the fibers are in a range of 6 mm to 12 mm, but may vary. Exemplary binder polymers may include polyvinyl alcohol, co-polyester, crosslink polyester, acrylic and polyurethane. Exemplary flame retardant binders may include polyamide and epoxy. Suitable wet laid techniques for forming the carbon veil may comprise a state of the art continuous manufacturing process. Generally, the amount of conductive fiber required depends upon the type of conductive fiber chosen, the voltage and power that will be applied to the fiber, and a physical size/configuration of the heating element.

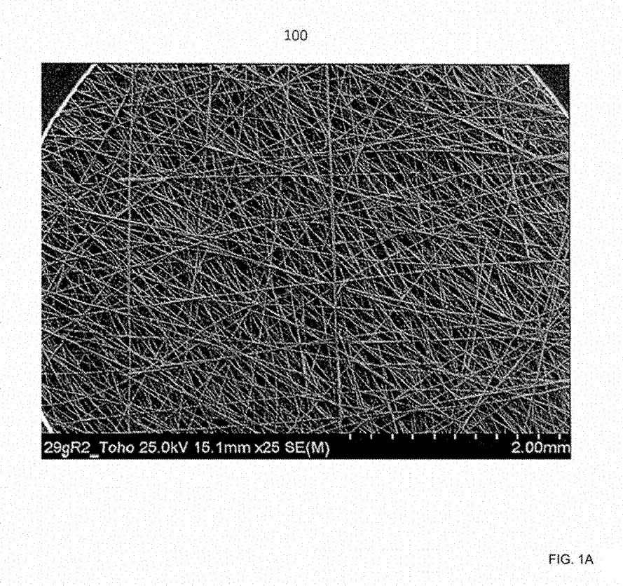

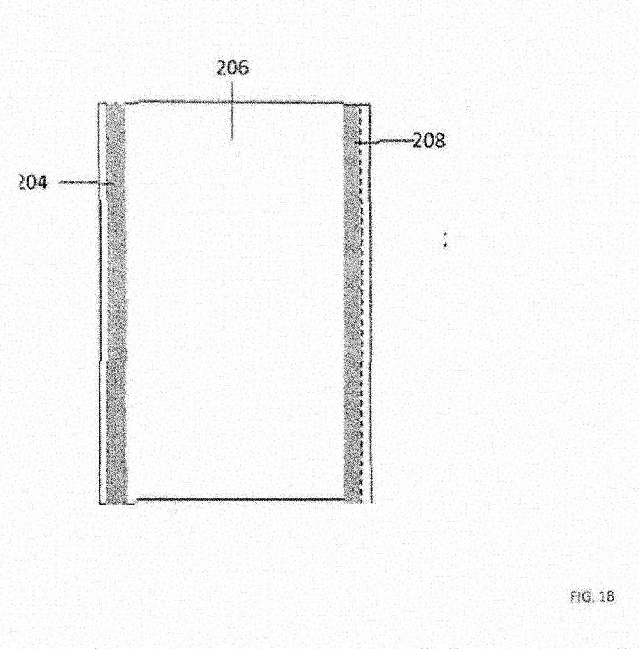

Carbon veils are beneficial for use in heating products in consumer applications (i.e., flooring) since they have desirable electrical characteristics, are exceptionally thin, and are relatively inexpensive to manufacture. Shown in FIG. 1A is a magnified photograph of a representative portion of an exemplary nonwoven fiber carbon veil that is well suited in connection with the claimed invention. As can be seen from the photograph, the fiber sheet comprises a plurality of individual, substantially straight untangled fibers all of which fall within a specified range of length (e.g., 6-12 mm). While each individual fiber of the nonwoven sheet is desirably in contact with one or more other individual fibers as part of a nonwoven structure of the sheet, ideal contact differs from entanglement in that entanglement typically involves two or more fibers wound around each other along a longitudinal axis of fibers, whereas preferred contact comprises straight, unentangled fibers having multiple points of contact with other straight unentangled fibers.

Shown in FIG. 1B is a top view of an exemplary heating element 100 comprising a carbon veil comprising electrically conductive veil busbar strips 204 and 208, which busbars typically comprise a copper layer coating over the carbon veil, and section 206 located between the busbars. Although not shown, in exemplary embodiments, electrical connectors are typically connected to each of the veil busbars to apply a voltage across the busbars that produces an electrical current flowing through the veil, which current causes section 206 to evenly generate heat resulting from the electrical resistance of section 206.

The carbon veil heating element may be manufactured at generally any size (length, width, and at any thickness, but preferably with a thickness of less than 1 mm, and more preferably with a thickness of <40 μm, and having a weight of <50 g/m2. The extremely low weight and thickness makes the carbon veil non-invasive such that it does not change the properties of a product into which it is embedded. Additionally, because the veil is porous, it lends itself to being embedded in products in which the product matrix impregnates the veil, such as in flooring products (e.g. vinyl, PVC, or other polymer flooring sheet products, linoleum, underlayment for tile, hardwood, carpet, etc.). The characteristics of the veil are particularly beneficial for use in flooring applications comprising thin sheeting products, such as polyvinyl chloride (PVC) flooring, which is typically only between 3 mm and 4 mm thick. The minimal thickness of the carbon veil permits it to be embedded just below the surface of the flooring (i.e., close to the walking surface). Embedding the carbon veil just below the walking surface of the flooring minimizes heat up time and energy consumption.

Performance of Heating Flooring Systems with Embedded Carbon Veils

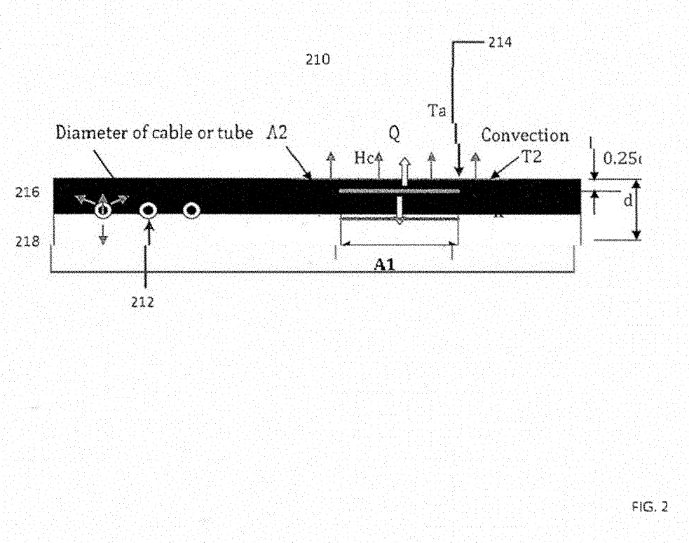

A comparison between exemplary installations of a conventional electric wire/liquid tubing heater and an exemplary embedded carbon veil is illustrated relative to a cross section of a floor structure 210 depicted in FIG. 2. Specifically, electrical wires and/or tubing 212 are shown installed between subfloor 218 and the flooring section 216. As shown in FIG. 2, the wires/tubes are buried a significant distance below the surface of the flooring section 216 and by their very nature constitute relatively hotter linear portions defined by each of the wires/tubes separated by relatively less hot spaces between the wires/tubes. In contrast, carbon veil 214 is embedded just below the floor surface and evenly covers an entire area A1. Generally, the carbon veil produces heat Q over surface area A2, which is transferred to the ambient air by convection. The equation for computing heat Q generated by the embedded carbon veil is described in equations 1 and 2 below.

$$\begin{matrix}{I}^{2} R = \frac{{kA}_{1} ( Ts - {T}_{1} )}{d} = {HcA}_{2} ( Ta - Ts ) = Q heat flow ( Watts ) & ( 1 ) \\ Q ∞ {A}_{1} k ( {T}_{2} - {T}_{1} ) = {A}_{2} Hc ( Ta - {T}_{2} ) & ( 2 )\end{matrix}$$

where H_{c}=thermal coefficient (constant)

K=thermal conductivity of floor material

T₁=Temp of heater element

T₂=Temp of floor surface

Tₐ=ambient air temp

A₁=surface area heating element

A₂=surface area of generated heat

Tables 1 and 2 below show a comparison between the characteristics of embedded carbon veil 214 and wires/tubes 212 shown in FIG. 2, based upon known characteristics of the Applicant's Power Film product, which comprises a coated carbon veil. The basic advantages of using an embedded carbon veil (Applicant's Power Veil product) are not materially changed versus the Power Film product. As shown in Table 1, the temperature of the heating element for the embedded veil only has to reach a temperature of 33° C., whereas the tubes 212 must reach a temperature of 49° C. and the electric wires 212 must reach a temperature of 81° C. to achieve the same temperature of 21° C. at the heated floor surface.

TABLE 1
(3)

For heating a square meter assume typically: k = 2 W/m² ° C.
Where: T₂ = 28° C. and Ta = 21° C.

| | Electric Cable | Water Heating |
|---|---|---|
| | Diameter = 1.5 mm | Tube dia = 16 mm |
| LaminaHeat ™ Film | Length 12 mts (twin core | Length = 6 mts (150 mm |
| Width = 1 mt Length 1 mt | 75 mm spacing) | spacing) |
| A₁ = 1 m2 | A₁ = 12 × 0.003 = 0.036 m2 | A₁ = 6 × 0.016 = 0.096 m2 |
| T₁ = 33° C. | T₁ = 81° C. | T₁ = 49° C. |
| Eq 1: −1 × 2 (24-33) = A₂ | Eq 1: −0.036 × 2 (28-81) = | Eq 1: −0.096 × 2 (28-49) = |
| Hc (21-28) | A₂ Hc (21-28) | A₂ Hc(21-28) |
| A₂-Hc = 1.43 m2 | A₂-Hc = 0.544 m2 | A₂-Hc = 0.576 m2 |

NOTE:
Hc is constant. If we assume Hc = 1 W/m2 ° C., this simplifies the calculations, and so A₂ = 1.43, 0.544, 0.576 m²

Thus, heating the floor to a desired temperature with an embedded carbon veil just below the floor surface only requires heating the carbon veil to a much lower temperature than the electric cable and/or the water heating tubes, the carbon veil based system consumes much less power.

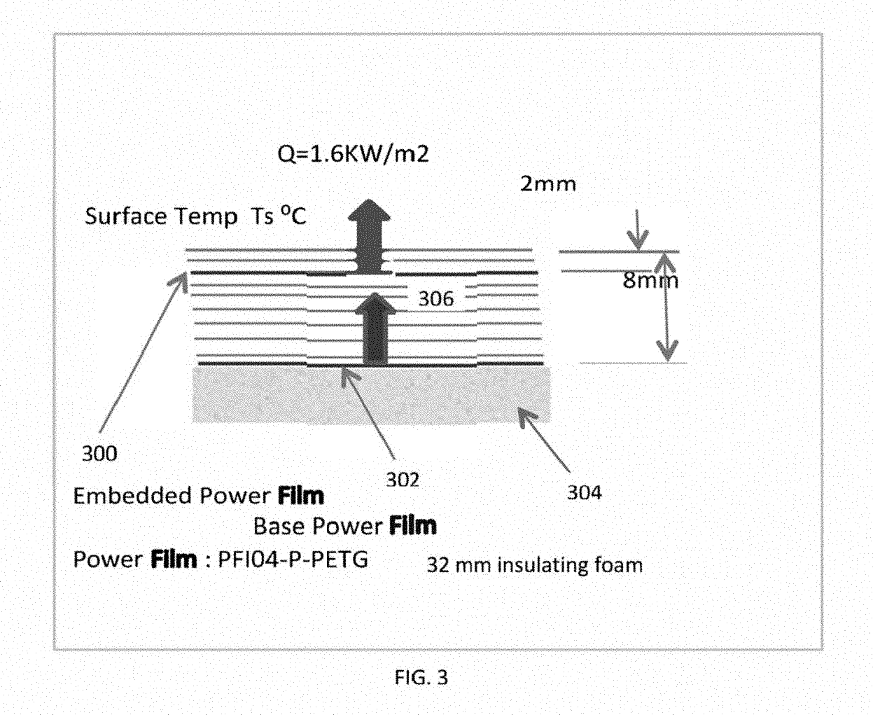

FIG. 3 further illustrates the impact of distance of the carbon veil relative to the floor surface. For example, the carbon veil in position 302 (at the “base”) between subfloor 304 and floor covering 306, is roughly 8 mm (“d” in FIG. 2) from the top surface of the floor, whereas when embedded directly into the floor at position 300, it is only 2 mm (“0.25d” in FIG. 2) from the walking surface of floor 306. In general, the closer the carbon veil is positioned from the top surface of the floor, the more efficient the carbon veil will be in heating up the floor surface.

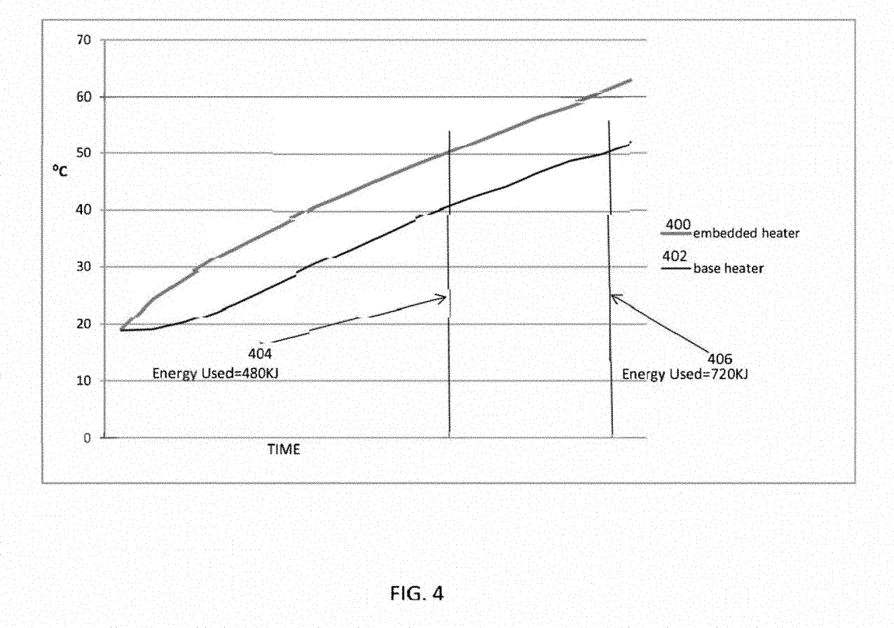

An example of the relative energy performance a veil embedded directly below the surface, and a veil positioned between the floor and subfloor, are shown in the plot of FIG. 4. Specifically, FIG. 4 shows a plot of time versus surface temperature of the floor for heat flow through a woven glass/epoxy laminate, which approximates the difference in having the embedded carbon veil heater just below the surface of the floor versus the carbon veil positioned in between the flooring and the subflooring. As illustrated in FIG. 4, the surface temperature of the flooring increases more rapidly when the carbon veil is positioned just below the floor surface. The embedded carbon veil utilizes approximately 42% less energy overall in the span of time depicted. Assuming 80% of the total energy is required in the heat up stage, and 20% of the total energy is required to maintain the surface temperature over a typical ON cycle of the heater, the difference in embedding height constitutes a difference that is essentially equivalent to (0.8×0.42)=34% energy savings. Thus, the overall energy usage of the Embedded Power Film is 0.66 the value of energy usage in the “Base” Power Film.

Table 2 shows the difference in energy needed for respective heating elements to supply the desired temperature, including the difference between positioning the carbon veil at “Embedded” and “Base” positions as described above.

TABLE 2

| Base LaminaHeat ™ Power Film ™ = | | 100 W/m² |
|---|---|---|
| Embedded LaminaHeat ™ Power Film ™ | 100 × 0.66 = | 66 W/m² |
| Electric cable heating systems | 3.32/1.22 × 100 = | 272 W/m² |
| Water heating systems | 3.32/1.35 × 100 = | 246 W/m² |

Exemplary Heated Flooring Systems with Embedded Carbon Veils

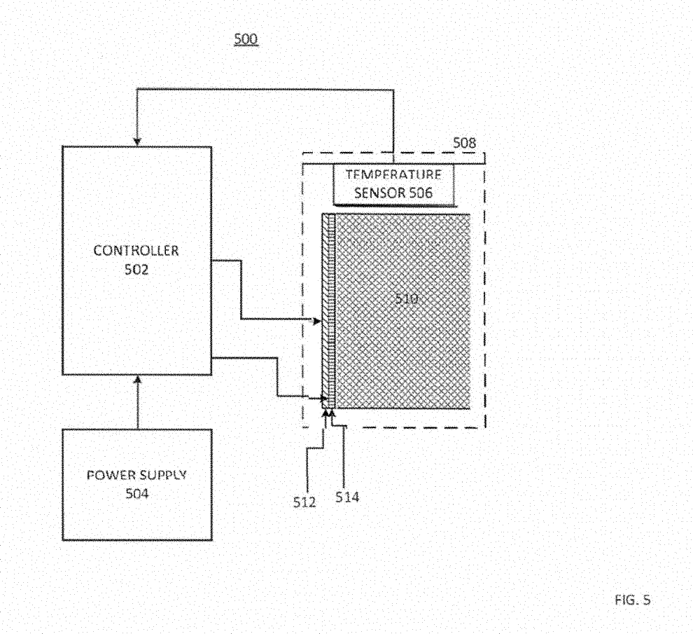

An example of a heated flooring system 508 including a controller is shown in FIG. 5. Specifically, FIG. 5 shows a system with a heated floor section 510, which has a carbon veil embedded directly below its walking surface. Separate from the heated flooring product 510 are electrical (floor) busbars 512 and 514, as well as an optional temperature sensor 506. In general, during operation, controller 502 controls the power supplied to floor busbars 512 and 514 via power supply 504. Power may optionally be controlled based on a temperature set point of optional temperature sensor 506. Because heated flooring section 510 includes the embedded carbon veil, during installation, the heated flooring product 510 is simply laid on the floor and then electrically connected to floor busbars 512 and 514. The floor busbars 512 and 514 may be integrated into busbar assembly that facilitates quick installation, as described herein later.

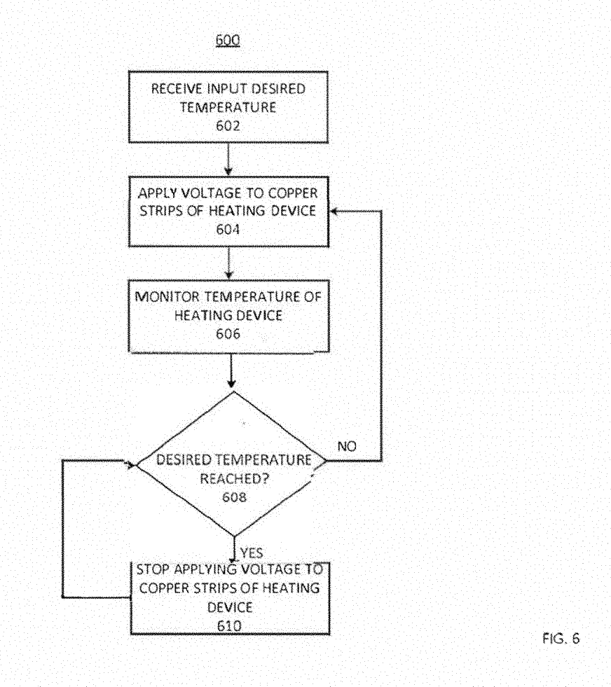

The operation of the heated flooring system shown in FIG. 5 is described in detail in the flowchart 600 of FIG. 6. In step 602, controller 502 receives an input from the user for setting a desired temperature (e.g., the temperature of the floor surface). The input device is not shown in FIG. 5, but can include a dial, button, touchscreen, etc. In step 604, controller 502 applies a predetermined voltage to floor busbars 512 and 514, which are electrically connected to the veil busbars in the carbon veil embedded within flooring 510. The carbon veil then produces heat in response to the electrical current flowing through it. In step 606, controller 502 uses either a timer or a control signal from temperature sensor 506 to monitor the temperature of the floor itself. For example, temperature sensor 506 (which is optional) may be in direct contact with the floor or in close proximity to the floor. In step 608, controller 502 then determines if the desired temperature of the floor has been reached. If the desired temperature of the floor has been reached, then in step 610, controller 502 stops applying voltage to busbars 512 and 514. If, however, the desired temperature is not reached, controller 502 continues applying the voltage to the busbars. The temperature sensor can thus cycle the power to the heater on and off as necessary, in accordance with any algorithm to known in the art for use in maintaining heated flooring or ambient air temperatures, to maintain a desired temperature at the floor surface or of the room, generally.

### Exemplary Installation Methods

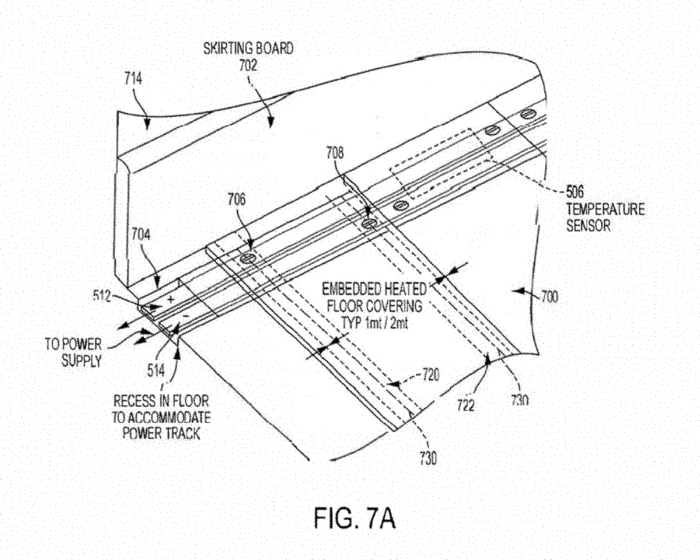

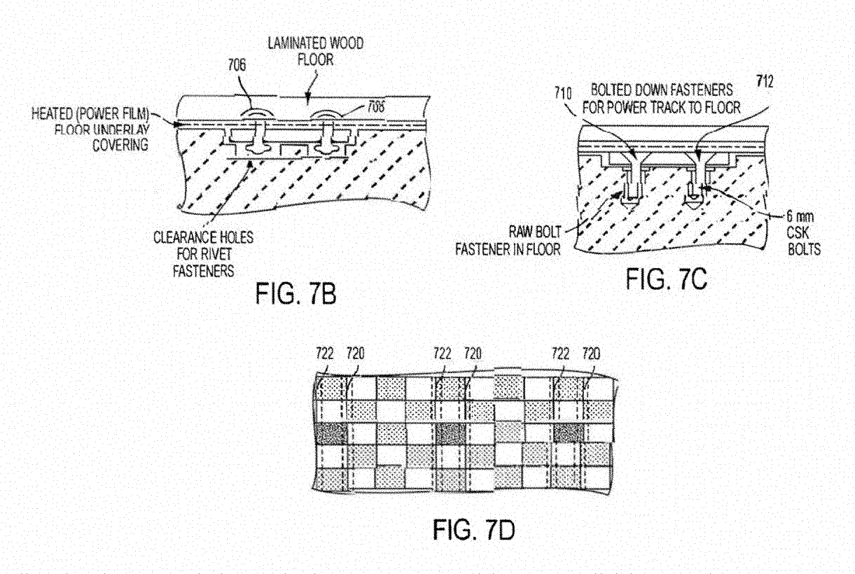

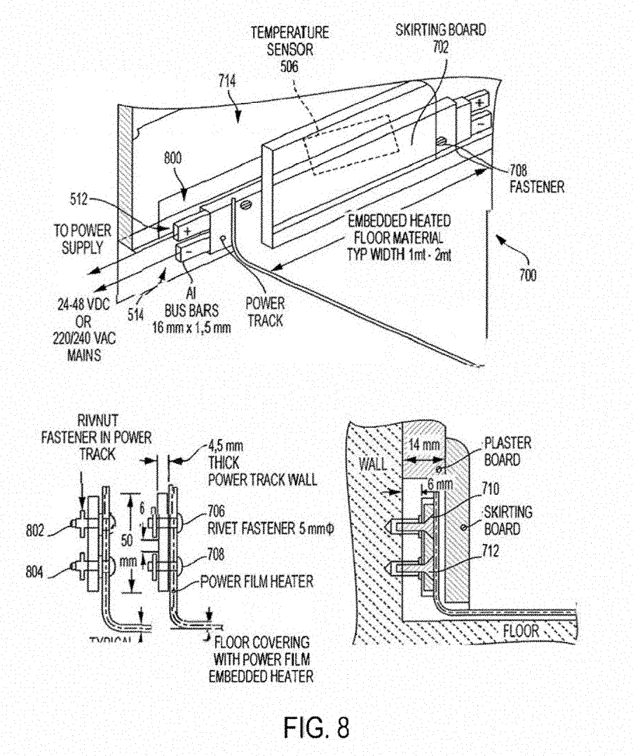

Embedding the carbon veil into the flooring product greatly simplifies installation of a heated floor. Exemplary installations of a PVC floor product with an embedded carbon veil are shown in detail in FIGS. 7 and 8.

FIG. 7 illustrates a PVC flooring product installed in a corner of a room adjacent a wall. During the installation process, a channel 704 is cut from the subfloor. A recessed floor busbar system, including busbars 512 and 514, is then installed in this channel, such as using a busbar assembly as described herein. Once the floor busbars are in place adjacent the baseboard 702 (also known as a skirting board or skirt board) of wall 714, the PVC flooring 700 with the embedded carbon veil may then be laid (e.g. using adhesive backing) over the desired area of the floor to be covered, including over the recessed floor busbar system. Thus, in the example illustrated in FIG. 7, the PVC flooring 700 not only covers the subfloor but also covers floor busbars 512 and 514.

To make electrical connections with busbars 512 and 514, conductive fasteners, such as bolts and/or screws or the like 706 and 708, are utilized to penetrate the flooring product through the veil busbars and into the floor busbars. Each conductive fastener essentially pierces the electrically conductive veil busbars of the carbon veil and therefore establishes an electrical connection from the veil busbars to the floor busbars 512 and 514 (i.e., respective positive and negative busbars are connected to one another).

FIG. 7 depicts exemplary cross sections of bolts 706 and 708 as well as an example of countersunk screws 710 and 712 that may be used. Temperature sensor 506 may also be installed inside the recessed portion of the subfloor (i.e., below the flooring) to be in close proximity to the flooring that it controls. Temperature sensor 506 (regardless of its installation location) provides the ability to sense the actual temperature of the floor, if desired, and report this information back to the controller. The connection between the temperature sensor may be wired (related wiring not shown in the figure, for simplicity, but the various connections required will be understood to one of skill in the art) or may be wireless, using Bluetooth® or any other wireless communication protocol.

In general, floor busbars 512 and 514 are connected to controller 502 as shown in FIG. 5. The controller 502 then applies voltage across these busbars which then conducts electricity through the carbon veil of the flooring product via the connection between the veil busbars in the carbon veil and the conductive fasteners 706 and 708 located periodically on the floor along the length of the floor to align with the veil busbars.

Alternatively, rather than create a channel in the subfloor, floor busbars 512 and 514 may be installed on or in the adjacent wall 714, as illustrated in FIG. 8. Although a channel or recess 800 may be cut into the wall to accommodate the floor busbars, the busbars may simply be installed on top of the wall and then covered by the baseboard.

In this example, once the busbars are installed on the wall or within the channel, the PVC flooring with the embedded carbon veil 700 may be laid on the subfloor. During installation, PVC flooring 700 may be cut to a greater length than the floor area to be covered, such that the flooring overlaps the wall a by a desired length (e.g. about 4 inches) to permit it to overlap the wall, wherein it is connected to floor busbars 512 and 514. The PVC flooring may be screwed directly to floor busbars 512 and 514 utilizing conductive fasteners in locations 706 and 708 or 802 and 804, similar to the installations described and shown previously on the floor, but in this case oriented on the wall rather than on the floor.

Once the flooring is installed throughout the desired area of the room, baseboard 702 may then be installed against the base of wall 714. The beneficial aspect of this embodiment is that not only are the floor busbars 512 and 514 hidden by the baseboard 702, but the fasteners 706 and 708 or 802 and 804 along the electrically connected edge of the floor are also covered by baseboard 702. This allows a seamless installation that is visually appealing, and also enables troubleshooting of the electrical connections by simply removing the baseboard rather than having to lift up a section of the flooring.

In the examples described in FIGS. 7 and 8, floor busbars 512 and 514 are connected to controller 502, which applies electrical current to the busbars. This electrical current then flows from the floor busbars through fasteners 706 and 708 and through veil busbars to create the electrical potential across the embedded carbon veil in the PVC flooring, which causes the carbon veil to emanate heat. This effectively produces an even heat throughout the entire flooring area due to the uniform resistance of the carbon veil and the more uniform coverage of the heated portions of the veil across the entire floor surface, as compared to the relatively small linear hot spots and relatively larger gaps therebetween created by systems employing electrical lines or water tubes of the prior art.

### Exemplary Manufacturing Methods

As described, a benefit to the overall system is that the carbon veil may be embedded directly into the flooring sheet itself (e.g., embedded directly into the PVC flooring). This embedding process is performed during manufacturing of the PVC flooring itself.

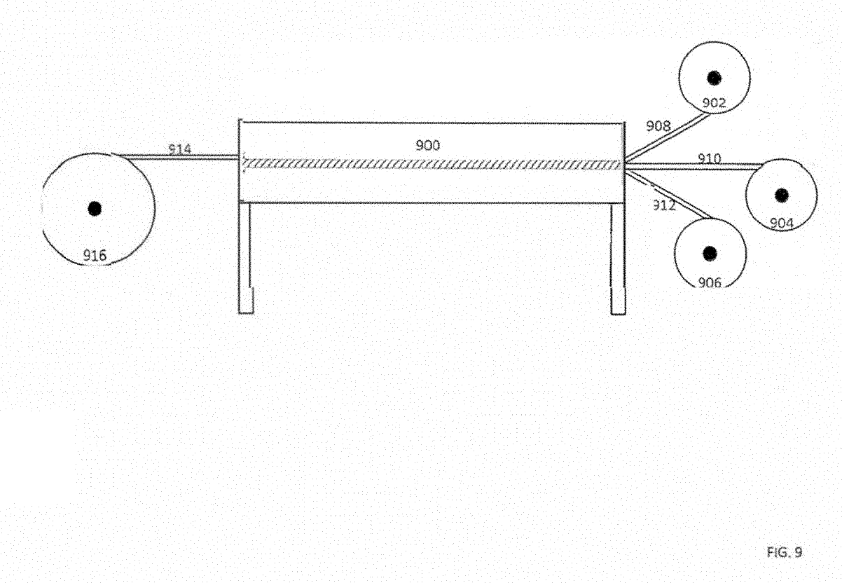

Shown in FIG. 9 is an exemplary process for manufacturing a PVC flooring sheet having an embedded carbon veil. An upper layer PVC sheet 908 fed from spool 902 and a lower layer PVC sheet 912 fed from spool 906 are fed into a laminator 900, with carbon veil 910 fed from spool 904 sandwiched between sheet 908 and sheet 912. Carbon veil 910 may be a “raw” carbon veil comprising only the veil with the conductive veil busbars applied thereto, or the veil may have a coating, such as a PVC or any other type of coating, on one or both sides, making the veil intermediate similar to Applicant's Power Film product, to facilitate bonding of the upper and lower layers to the veil intermediate. Spool 904 includes a carbon veil pre-cut to match the widths of the upper and lower PVC sheet layers dispensed from spools 902 and 906, and has at least one set (typically multiple sets) of veil busbars embedded therein at a desired spacing from one another. All three layers are laminated together to produce a PVC flooring product 914 with an embedded carbon veil. Although discussed herein in connection with a PVC flooring product, it should be understood that a similar technique may be used for the manufacture of flooring from any non-conductive material capable of being laminated or otherwise joined together to sandwich the carbon veil therebetween. Additionally, although depicted with only a minimum number of three layers, it should be understood that additional layers may be present above or below the upper and lower layers sandwiching the veil as shown and described herein.

Finally, although well suited PVC flooring products that serve as the upper layer surface covering, the flooring products as described herein may refer to underlayments, such as may be installed under carpet, tile, hardwood, etc. Although the veil will typically be more than 1 mm below the uppermost floor surface when embedded in such an underlayment, the advantages of low energy consumption and evenly distributed heat are still present. Thus, for example, the flooring product as described herein may comprise an acoustic underlayment film. Typically, such films are typically 1.0 to 2.0 mm thick with a 2-3 mm insulating foam backing. The carbon veil may be thus embedded between the film and the foam. Such a veil may be manufactured by a lamination process as described above, or in an extrusion process, in which the polymer melt from the film extrusion penetrates the porous veil and fuses the acoustic film to the insulating foam.

It should also be understood that although described herein with respect to a flooring product, the manufacturing process herein described is not limited only to floor coverings, but may also be used to create any laminar product for any use known in the art, and may be particularly useful for fabricating wall coverings as well as tarps or covers. In particular, a laminating process as described above may be used for creating a heated tarp or cover for a dump truck or other open top truck, to prevent ice or snow build-up during the winter that may otherwise create a hazard for other drivers when built-up ice sloughs off non-heated covers at highway speeds. Thus, for example, a carbon veil as described herein may be embedded into a 3 mm thick PVC tarpaulin layer during production, similar to the method as described herein for flooring, so that the veil is safely embedded approximately 1 mm below the outer surface of the tarp and activated via the truck battery by a controller. The controller may, for example, have inputs connected to a sensor configured to sense a combination of moisture and temperature at which to apply heat to prevent ice build-up. Power connections to the tarp may be provided using a power cord with a positive terminal attached to one veil busbar and a negative terminal attached to the other veil busbar, using connectors that affix to and penetrate the tarp and the veil busbars in the appropriate positions.

For manufacturing of finished products in sheet form, it is therefore beneficial to provide the carbon veil in a spool or roll form comprising the carbon veil of a desired width, with the veil busbars spaced at desired widths to provide a desired level of heating potential. PVC flooring manufacturers can then simply order a spool of a carbon veil of a desired width and length with veil busbars at a desired spacing to provide a desired heating capability. This spool can then simply be fed into the already existing PVC floor laminating machinery along with the other layers of the PVC flooring to produce an overall heated floor product.

### Busbar Assemblies

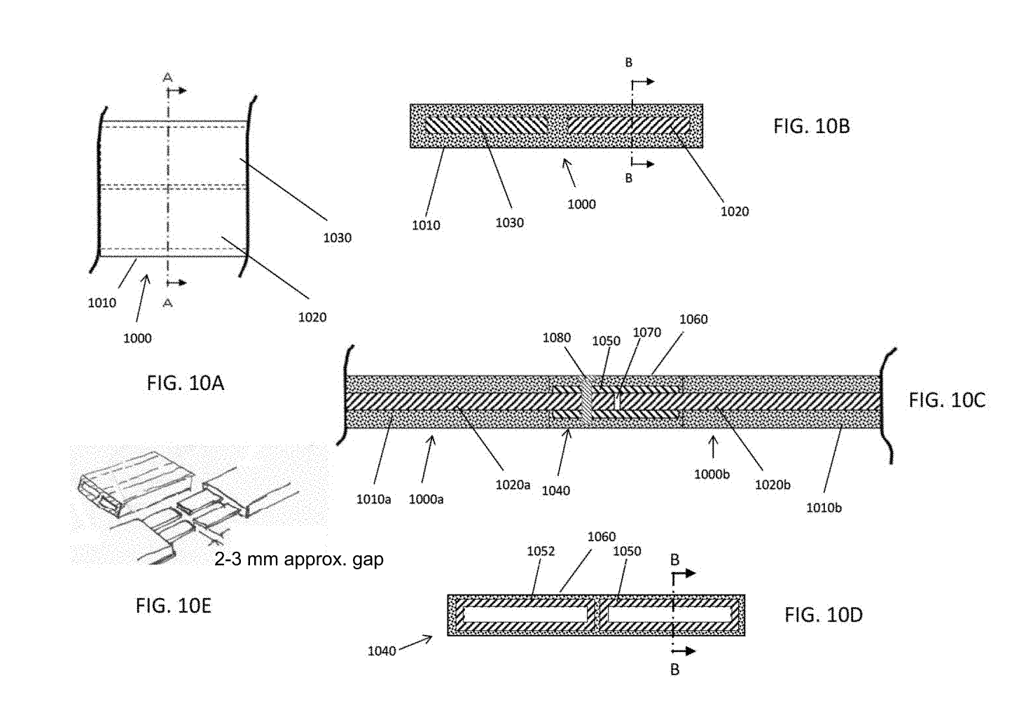

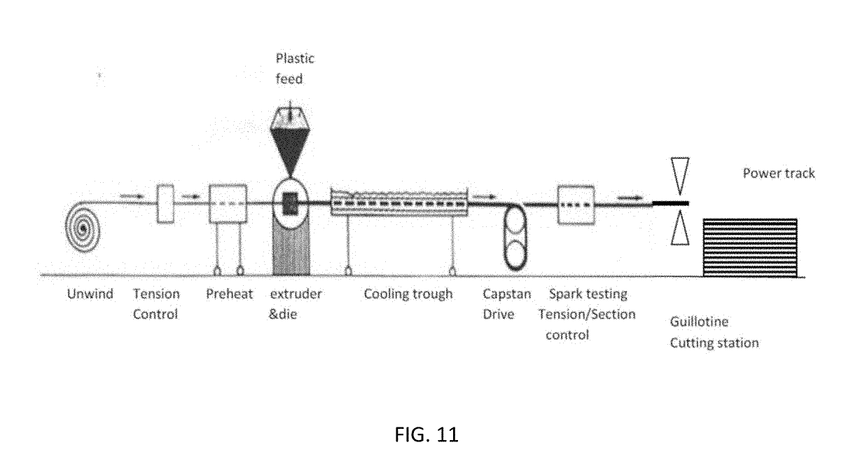

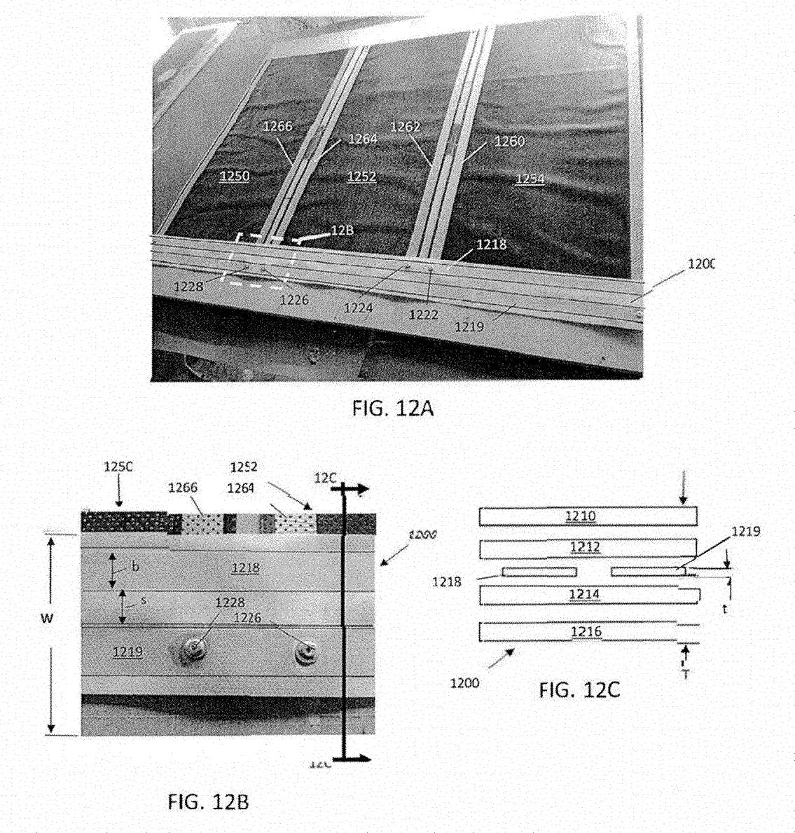

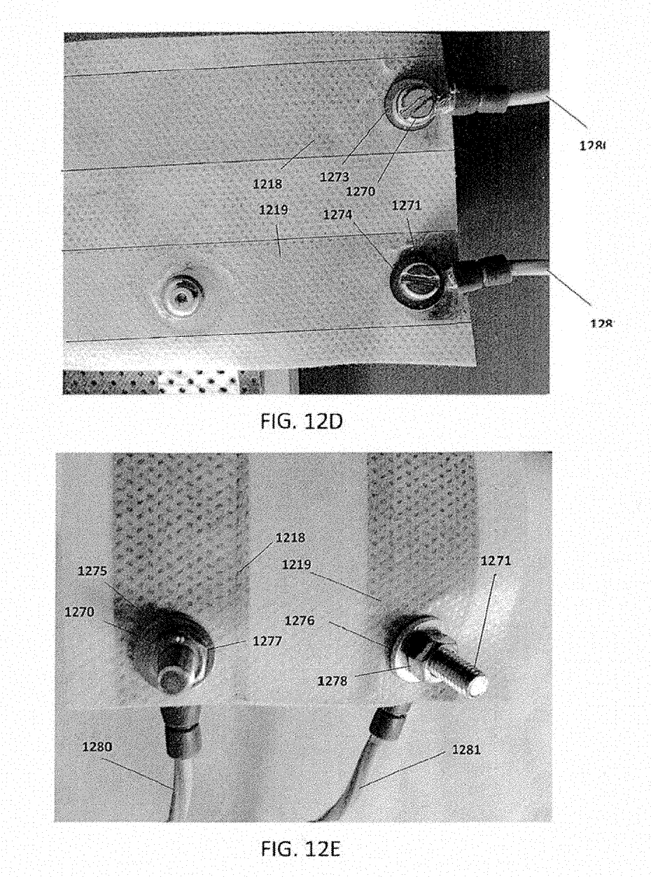

To facilitate easy installation of the flooring system described herein, sets of two or three conductive floor busbars may be integrated together into a single product comprising the busbars bound together in a common insulation matrix, as shown in FIGS. 10A-10B and 12A-12B. In the exemplary embodiment illustrated in FIGS. 10A-10B, each busbar may have a rectangular cross section of 20 mm wide×1.5 mm thick, may comprise preferably pure aluminium grade or copper electrical grade materials of construction, and may have an extruded polymer sheath, such as 1.5 mm thick PVC. FIGS. 10A and 10B depict a 2-busbar product 1000 in which, for example, the “hot” busbar may be busbar 1030 and the neutral busbar may be busbar 1020, or vice versa, contained together in an insulation matrix 1010. Such a product may be manufactured, for example, as depicted in FIG. 11.

As shown in FIG. 11, each busbar at the desired width and thickness and materials of construction may be supplied into the manufacturing process wound on a spool. The respective busbars are unwound and fed through a tension controller and a preheating step, and into a die of an extrusion system that extrudes the plastic insulation around the busbars. The combined product goes through cooling trough and a capstan drive, through another tension controller, and then cut into desired lengths at a cutting station. The manufacturing process may also comprise a “spark testing” step to confirm the busbars are properly spaced and separated from one another in the combined product and do not present a risk of arcing or shorting, which testing step is depicted adjacent the downstream tension controller, but is not limited to any particular location after the extrusion and cooling step. The general process steps for extruding insulation onto a multiple metal members are well known in the art and further explanation is not necessary to be understood by those of skill in the art.

Returning to FIGS. 10A-10E, one exemplary busbar assembly system may be supplied in one or more standard lengths, which lengths can then be joined with connectors, as depicted in FIGS. 10C-10E. As shown in FIGS. 10D and 10E, each length of busbar assembly is preferably provided for installation with a predetermined length of each busbar protruding from the insulation on both ends (which may be accomplished as part of the manufacturing process by sending the cut lengths through a stripping station). Connector 1040 comprises insulation 1060 surrounding hollow conductive sheaths 1050 and 1052, each sheath dimensioned to slip over the protruding ends of the busbars. The connectors may be manufactured in a similar manner as the busbar assembly, except with continuous spools of sheath material, comprising a rectangular annular cross section as shown in FIG. D, supplied to the extrusion step instead of busbars, and the connectors are cut into much shorter lengths than the busbar assembly lengths. As depicted in FIG. 10C, during installation, a first length of busbar assembly 1000a may be joined to a second length 1000b using connector 1040. As shown in FIGS. 10C and 10E, the busbars, when joined, may have a gap 1070, such as for example, 2-3 mm, between the busbar 1020a of assembly 1000a and busbar 1020b of assembly 1000b. The electrical connection between the 1020a and 1020b may rely upon an interference fit between the conductive sheath and the busbar as shown for busbar 1020b in FIG. 10C, or may further comprise a conductive fastener 1080 applied to pierce the sheath and busbar, as shown for busbar 2020a in FIG. 10C. The fastener design may resemble any of the other fasteners depicted herein, may or may not protrude completely through the insulation on both sides of the connector, but preferably any protruding features of the fastener are insulated either as provided, or by adding an electrical insulator over top, such as using tape or the like.

FIGS. 12A-12E depict a thin-profile busbar assembly embodiment having a much thinner profile than the embodiment depicted in FIGS. 10A-10E. As shown in FIG. 12C, assembly 1200 may comprise busbars 1218A, 12188 comprising strips of conductive material disposed within sheets of insulation 1212, 1214. In some embodiments, strips of freestanding conductive material (e.g. such as from a spool or reel) are fed between the insulating layers (which may also be provided from a roll, spool, or reel) into a continuous laminating machine that laminates the layers together by melting the polymer insulating materials under pressure and temperature around the conductive strips. The strips of conductive material may also be prepared by printing, coating, depositing, or otherwise disposing the conductive material on a carrier sheet or onto the inside face of one of the insulating layers before laminating the insulating layers together. The invention is not limited to any particular manner of constructing the thin-profile busbar assembly.

For example, the conductive strips may have a thickness T in a range of 50 micron to 200 microns, and a width W in a range of, preferably 10 to 80 mm, or more preferably 20-65 mm, depending upon the amperage rating of the strips. The busbars are not limited to any particular dimensions, although the width is characteristically much greater than the thickness, such as but not limited to a ratio within the ranges disclosed herein later. The insulation may comprise layers of PVC film insulation having a thickness in the range of 50-200 microns, or more preferably about 100 microns. The insulation may have additional layers disposed therein, such as a non-woven PEN scrim having a density of, for example but not limited to a range of, preferably 10 gsm to 100 gsm, more preferably 20-50 gsm, or most preferably about 36 gsm, to promote bonding of the assembly to substrates such as plaster or cement. The layers are preferably laminated together. The various layers may have adhesive therebetween or thereon. In other embodiments, the lamination step may be conducted at sufficient heat and pressure to cause at least some of the polymer materials in the multilayer structure to melt together.

As shown in close-up in FIG. 12B, the thin-profile busbar assembly 1200 may be connected to the structures powered by them, such as corresponding busbars 1264, 1266 of veil heaters 1250, 1252, using rivet connectors 1226, 1228. Specifically, as shown in more detail in FIG. 12A, a plurality of veil heaters 1250, 1252, 1254, may be connected to one another by busbar assembly 1200. In one exemplary configuration, the busbar 1218 may be connected to the positive pole of an electrical power source and strip 1219 may be connected to the negative pole of the electrical power source, such as via wires and connectors as described herein later. Showing two adjacent intersections, one of which is shown in more detail in FIG. 12B, the positive busbar 1218 is connected to veil busbar 1260 of veil 1254 by rivet 1222 and to veil busbar 1262 of veil 1252 by rivet 1224, and the negative busbar 1219 is connected to veil busbar 1264 of veil 1252 by rivet 1226 and to veil busbar 1266 of veil 1250 by rivet 1228. The opposite polarities of veil busbars 1262 and 1264 cause electricity to flow between the veil busbars, as described herein. Each rivet may have an electrically conductive member that penetrates the busbars, thereby electrically connecting the busbars, and may have a non-conductive exposed surface (such as rivets with the rivet heads coated with a non-conductive material, such as a dip coat of nylon). In alternative constructions, each rivet may be entirely conductive and covered on its exposed surfaces with a non-conductive material, such as with non-conductive tape or a non-conductive coating, such as polymeric or elastomeric sealer, to provide electrical insulation. The connectors are not limited to rivets, however. For example, in a floor heating system installed on a wood subfloor, conductive wood screws may be provide the electrical coupling required for the busbars as well as the mechanical connection to the wood floor.

As shown in FIGS. 12D and 12E, the end of each busbar assembly may be connected to a power supply via cables 1280, 1281. For example, in the example previously given, busbar 1218 connects via cable 1280 to the positive pole of a power supply, whereas busbar 1219 connects via cable 1281 to the negative pole of a power supply. The power supply may be any type of power supply known in the art, preferable a power supply configured to provide applied voltages in the range of 24 to 400 volts of AC or DC. The connection between the cables 1280, and 1281 may be made by any type of connector known in the art, but in the simple example shown in FIGS. 12D-12E, cables 1280, 1281 are crimp connected to respective fittings 1273, 1274, which are configured to receive bolts 1270, 1271 secured with nuts 1277, 1278 and washers 1275, 1276. The invention is not limited to any type of connectors or wiring harnesses, however, and any number of low-profile quick connectors may be devised for easier assembly of flooring systems. The connectors and any exposed conductive metal may be covered with a non-conductive material, such as insulating tape. Although shown attached to veil heating elements, it should be understood that the thin-profile busbar assemblies as depicted herein may be used to convey electrical power and/or electrical signals to any type of installation instead of standard round core electrical power cables widely used for this purpose. The thin-profile busbar assemblies are particularly useful for connecting heating systems, such as floor heating systems used in heated buildings for the building/construction industries and other market segments.

In a typical round core wire applications in which the cables need flexibility, typical flexible cables feature insulated wires in a bundle, typically wrapped in a polymer and/or a textile to reduce friction. Friction caused by movement causes heat, which can lead to overheating. Use of flexible cables in an environment in which the cables move frequently over a period of time may also cause elongation or stretching of the cables after continuous use, which elongation or stretching leads to unstable electrical properties. By contrast, the thin-profile busbar assemblies disclosed herein are very flexible but also stable in geometry. A PVC outside insulating sleeve is often used in round core insulation layers. By contrast, the busbar embodiment described herein does not require the use of low friction materials in the cable because the busbars do not move relative to one another. This embodiment also offers other advantages over standard round core cables. The thin-profile design provides better heat dissipation than round cables, because there is more surface area for a given volume of conductive material. This larger surface area permits the flat conductive (typically copper) bus bars in the thin-profile busbar assembly to carry a higher current level or ampacity for a given temperature rise and for conductors of a given cross section. Thus, the thin-profile busbar assemblies described herein use less copper (e.g. typically up to 250% less) for the same ampacity compared to round cable

The thin-profile busbar assembly is thin (typically 350-500 microns thick, overall) and is therefore more flexible than standard round cables, for cables rated to carry the same amount of power. Because the thin-profile busbar assembly comprises very thin layers of conductive material, preferably copper, more preferably pure copper, disposed in a thin layer of insulation, such as PVC, some embodiments of the busbar assembly are transparent or translucent in the non-conductive portions, which allows easier use and simplifies coding, inspection, quality control and trouble shooting. The thin-profile allows easier installation, particularly in buildings or in retrofits, because there is no need to bury cables in the brickwork or concrete. In embodiments with scrim layers 1210 and/or 1260, the busbar assembly can be directly bonded to surfaces and embedded directly in materials. Some embodiments may further comprise a contact adhesive surface on the outer surface of one or more of outer layers 1210 or 1216, for direct bonding to a surface. In such instances, the contact adhesive may have a peelable layer over top that is removed to reveal the contact adhesive. Thus, in some embodiments, both outer layers 1210, 1216 may comprise a contact adhesive mounted on a first film, with a second peelable film as a cover. In installations in which the contact adhesive is desired, the second film may be removed. In installations that do not need the contact adhesive, one or both of the peelable layers can be left intact.

Exemplary dimensions of thin-profile busbar assemblies as disclosed herein are found in Table 3, with reference to “b” and “W” as indicated in FIG. 12B, and “T” and “t” as indicated in FIG. 12C. The space “s” between busbars is preferably about 15 mm.

TABLE 3

| | | | | | | | Amps per |
|---|---|---|---|---|---|---|---|
| | | W | | | Busbar | Track | cross- |
| Busbar | Busbar | assembly | T assembly | Max | width to | width to | sectional |
| width b | thickness t | width | Thickness | Rated | thickness | thickness | area |
| Mm | μm | mm | μm | Amps | ratio | ratio | (A/sqmm) |
| 20 | 50 | 65 | 350 | 20 | 400 | 186 | 20 |
| 30 | 50 | 85 | 350 | 32 | 600 | 243 | 21 |
| 22 | 100 | 67 | 400 | 40 | 220 | 168 | 18 |
| 25 | 100 | 75 | 400 | 50 | 250 | 188 | 20 |
| 30 | 150 | 85 | 450 | 64 | 200 | 189 | 14 |
| 33 | 150 | 91 | 450 | 70 | 220 | 202 | 14 |
| 30 | 200 | 85 | 500 | 80 | 150 | 170 | 13 |
| 35 | 200 | 95 | 500 | 90 | 175 | 190 | 13 |
| 40 | 200 | 105 | 500 | 100 | 200 | 210 | 13 |
| 55 | 200 | 135 | 500 | 128 | 275 | 270 | 12 |

Thus, the ratio of busbar width to thickness in the thin-profile busbar assembly embodiment is greater than 100, and preferably in a range of 100-700, and more preferably in a range of 150-600. The overall track width to track thickness is also preferably over 100, preferably over 150, and more preferably in a range of 150-300. The rated amperage per sqmm of cross sectional area of the busbar (which corresponds to the amps per weight of conductive metal needed), is in the range of 10-25, and more preferably 12-21. Any number of additional ratios may be calculated using the values shown in the table above, which values are merely exemplary for one embodiment, and non-limiting.

It should be understood that although depicted in the figures as a 2-busbar assemblies (and corresponding connectors, in the applicable embodiment), embodiments with three busbars are essentially identical to the examples depicted herein, but with one extra busbar. Similarly, it should be understood that single busbar assemblies may also be manufactured using a similar process (and connected together using similar, single-busbar-sheath connectors, in the relevant embodiment). The busbar assemblies as described herein are not limited to any number of busbars. Whether integrated together in assemblies depicted herein, or separately, the insulated busbars or assemblies thereof may be manufactured in a continuous length and cut to length as required.

Although the floor busbars may be preferably provided in an assembled configuration for ease of installation, the invention is not limited to any particular configuration for the floor busbars. Similarly, although the busbar assemblies described herein are shown in combination with a veil heating system, such as for use in a floor, the assemblies described herein are not limited to any particular use.

### Detailed Installation Example

Below are exemplary details of an exemplary system as described herein. It should be understood that this example in no way limits the invention to any of the specific details or characteristics provided, but is merely provided as one example of an operative installation.

Connection System

1) Floor Busbars

Metal electrical busbars (typically 2 or 3) with pure aluminium grade or pure copper electrical grade materials of construction. Busbars may be integrated in busbar assembly, as described above, or may be individually coated with insulation, such as an extruded polymer sheath. The busbars, whether integrated together in a busbar assembly, or separately, may be manufactured in a continuous length and cut to length as required.

2) Fasteners

Metal rivets or RIVNUT® brand metal fasteners, aluminum or stainless steel, 5 mm dia×12 mm long typical. CSK or flat head type. Protruding features of the fasteners are preferably insulated or isolated from where they might pose a risk of shock or current drain, either by the materials of construction of the subfloor and flooring materials, or by other means, such as an insulating tape covering, not shown. For example, as shown in FIG. 7B, rivet fasteners may be used in conjunction with recesses in the subfloor and may be covered by the laminated flooring to electrically isolate the fasteners, and bolts may be screwed into an insulating bolt fastener, and may be countersunk, as shown in FIG. 7C. Although depicted in connection with one type of floor busbar embodiment, the use of fasteners, isolation of those fasteners, and countersinking of those fasteners is applicable to all types of busbar embodiments shown and described herein, as well as any other busbar assemblies known in the art of later developed.

3) Busbar Assembly
a) For relatively thick profile busbar assembly (e.g. FIGS. 10A-10E): Fix busbar assembly to wall using stand-off bushes (e.g. nylon 6 mm long and M6 CSK fixing screws) or to floor using standard raw plug in floor for M6 CSK screw. For thin-profile busbar assembly (e.g. FIGS. 12A-12E). Fix busbar assembly to wall or to floor, such as by using an adhesive, such as by exposing an adhesive embedded in the assembly by peeling off a covering.
b) Lay floor covering with embedded heater, typically 1 meter wide or 2 meter wide, on floor and, if connecting to wall-mounted busbar assembly, up the wall to overlap the busbar assembly. Cut to length.
c) For relatively thick profile busbar assembly only: Drill 5 mm dia hole through flooring and power busbar assembly.
d) Install rivet fastener using automatic rivet gun. (No pre-drilling needed for thin-profile busbar assembly).
e) For each heater zone or width (i.e. each section of the flooring corresponding to a section of the veil located between a corresponding set of veil busbars), install 1 fastener to positive (+) busbar and 1 to negative (−) busbar, in positions that align with the corresponding veil busbars, which veil busbars are preferably clearly visible, such as in the cross section of the flooring on the cut edge, or more preferably to enhance installation, as marked with visible indicia on the upper or lower surface of the flooring. Markings on the lower surface may be permanent, but may require the installer to continually lift the flooring to ensure alignment. Thus, markings on the upper surface may be more preferably, and may be marked in a temporary or removable form, such as in an ink that is easily removed by washing with water or a floor cleaning solution, or in a floor covering having a permanent pattern or design thereon, aligned with a portion of the pattern in an easily distinguishable way.
For example, as shown in FIG. 7A, lines 730 may comprise temporary or removable markings on the upper surface of the flooring product, marking the centerline of each veil busbar 720 and 722 (hidden location of busbars shown in dashed lines). The installer may know from the spacing which is positive and which is negative, or the markings may further include a marking that indicates polarity. Instead of temporary or removable markings on the upper surface of the floor, the flooring product may have a permanent marking on the underside. In another embodiment, shown in FIG. 7D, a pattern of the flooring may mark the location of the veil busbars. In the non-limiting and illustrative example, shown in FIG. 7D, each black square in an otherwise white and gray checked pattern may indicate the locations of the centerlines of the veil busbars as corresponding to the lines dividing the gray and white squares that align with the black square. An infinite number of patterns capable of providing such a marking are possible.
f) Repeat for other fastener positions
g) Connect a power cable to each floor busbar assembly at one end of the power cable and to thermostat or heater controller at the other end.
h) For a wall application, install baseboard to cover the busbar assembly.

4) Power Supply
Supply to busbar assembly may be via low voltage transformer 24-48 V DC or alternatively 220/240 V AC supply. A low voltage supply typically requires only two bus bars (Live/Neutral) in the busbar assembly, whereas high voltage typically requires three bus bars (L/N/E) including the earth (ground) connection. A typical power supply for a floor installation of 4 meters×4 meters may be 2.3 KW. For low voltage (e.g. 48 V DC), 2.3 KW may be provided using a transformer with primary voltage of 240 V AC, at 10 amps, and secondary voltage at 48 V DC, at 50 amps.

### SUMMARY

Heated flooring with an embedded carbon veil heats up quickly and consumes little energy. Carbon veils and thin-profile busbar assemblies may be inserted into very thin products that traditional wires/tubes cannot typically accommodate. The carbon veil and thin-profile busbar assemblies do not add any significant thickness to the overall product and do not negatively affect installation of the product. In addition, the carbon veil, due to its nonwoven structure, always maintains a constant resistance regardless of the size of the veil. This is an additional benefit relative to standard electrical wires, which have a non-uniform resistance, in which the resistance increases with the wire length. Similarly, liquid filled tubes also provide uneven heating over their length, because the liquid temperature drops over the length of the tube as heat dissipates along the run.

The thin-profile busbar assemblies as described herein are especially well suited to bonding to a substrate, because of their large bonding area, and in particular in embodiments comprising a surface scrim of PET on the bonding surface. Although described primarily herein with respect to installations in floors, it should be understood that the subject systems are suitable for installation on or in any type of surface, including but not limited to floors, walls, and ceilings. Similarly, although described in one embodiment in which the busbar assembly is mounted on a wall adjacent the floor in which the heating elements are disposed, the busbar assembly may be mounted on the same surface as the heating elements or on any surface adjacent thereto. Thus, the heating elements may be on a wall, and the connecting busbar assembly in the floor or the ceiling, or for heating elements in the ceiling, the busbar assembly may be mounted on the wall. Alternatively, the busbar assembly and the heating elements may all be mounted to the same surface.

The thin-profile busbar assemblies, and accompanying heating elements, may also be included in flexible multilayer structures, such as tarps and covers as described herein, and in surfaces other than walls, floors, and ceilings (e.g. a counter, a car seat, a towel warmer, etc.). Although well suited for installation on typically planar surfaces, the flexibility of the thin-profile busbar assemblies and carbon veil heating elements permits installation on non-planar surfaces. Additionally, the heating elements and connected thin-profile busbar assemblies may be readily embedded in plaster, cement, or other wall, ceiling, or floor coverings (e.g. wall paper, ceiling tiles, paint/coating systems), particularly embodiments in which the heating elements and busbar assemblies have outer layers or surface treatments that promote bonding with the materials in which they are embedded.

In wall and ceiling embodiments, the thin-profile busbar assembly and connected planar heating elements may be mounted to the surface with an adhesive, such as an adhesive designed for bonding to plaster and concrete with long term durability in the building construction applications, and then covered over with plaster, wallpaper, fabric, paint, or the like. For example, a thin coating of plaster 1-1.5 mm thick may be applied over the heater, and then wallpaper or paint is applied over the plaster. Embodiments of the heater and thin-profile busbar assembly incorporating a polyester scrim non-woven material as an outer layer are particularly compatible with plaster/concrete substrates. In preferred embodiments, the maximum temperature of the heater is limited to 45 degrees C., which avoids detrimental effects to wallpaper, paint, or other coverings over the plaster. A typical voltage used in wall, ceiling, or floor embodiments for residential or commercial applications is 36 v AC, which poses no risks if a homeowner or other occupant inadvertently were to drill a hole in the wall or poke a nail or screw through a carbon fiber heating element or a busbar (so long as the nail/screw/hole does not completely sever the busbar. Thus, the design of the system and operations at low voltages are well suited to provide safe operation even in the event of abuse.

It should be understood that the invention is not limited to any particular materials of construction nor to any particular structural or performance characteristics of such materials, but that certain materials and structural performance characteristics may provide advantages, as set forth herein, and thus may be used in certain embodiments. Furthermore, it should be understood that the invention is not limited to any particular combination of components, and that each of the components as described herein may be used in any combination with any other components described herein.

In addition, although the invention is illustrated and described herein with reference to specific embodiments, the invention is not intended to be limited to the details shown. Rather various modifications may be made in the details within the scope and range of equivalence of the claims and without departing from the invention.

What is claimed:

1. A heating system comprising:
an carbon veil heating element embedded between layers of insulating material, the carbon veil heating element having at least two electrically conductive veil busbars spaced apart from one another;
a connector busbar assembly comprising at least two connector electrical busbars and a matrix of insulation connecting the at least two connector electrical busbars together, each of the at least two connector busbars configured to be electrically connected to one of the at least two veil busbars;
at least two conductive fasteners, each configured to protrude through and electrically connect one electrical busbar in the connector busbar assembly to one veil busbar in the carbon veil heating element; and
a controller configured to be electrically connected to the connector busbars and to apply electrical current to the connector busbars sufficient to cause the at least one carbon veil heating element to produce heat in a portion thereof located between the veil busbars.

2. The heating system of claim 1, wherein the at least two connector busbars comprise a conductive metal having a rectangular cross section with a width, a thickness, and a ratio of the width to the thickness greater than 10.

3. The heating system of claim 1, wherein the outer surface of at least one layer of the insulating film comprises visible indicia aligned with each busbar of the embedded carbon veil heating element.

4. The heating system of claim 1, further comprising at least one additional layer disposed over at least one of the opposing layers of insulating film.

5. The heating system of claim 4, wherein the at least one additional layer comprises a non-woven scrim.

6. The heating system of claim 4, wherein the at least one additional layer characteristically promotes bonding of the busbar assembly to plaster or cement.

7. The heating system of claim 4, wherein the at least one additional layer comprises a contact adhesive.

8. The heating system of claim 7, wherein the at least one additional layer comprising the contact adhesive is covered by a removable covering.

9. The heating system of claim 2, wherein the ratio of width to thickness of the conductive metal is greater than 100.

10. A method of installing a heating system, the method comprising the steps of:
providing the heating system of claim 1;
disposing the at least one carbon veil heating element on or in a surface;
electrically connecting the connector busbar assembly to the veil busbars in the at least one carbon veil heating element using the at least two conductive fasteners; and
electrically connecting the connector busbar assembly to the controller.

11. The method of claim 10, comprising disposing the at least one carbon veil heating element on or in a surface that comprises a floor, a wall, or a ceiling of a building.

12. The method of claim 10, comprising disposing the connector busbar assembly on or in the same surface as the at least one carbon veil heating element.

13. The method of claim 10, comprising disposing the connector busbar assembly on or in a surface different from but adjacent to the surface in or on which the at least one carbon veil heating element is disposed.

14. The method of claim 13, comprising disposing the at least one carbon veil heating element on or in a section of flooring and the connector busbar assembly on or in a wall adjacent the section of flooring.

15. The method of claim 14, comprising disposing the connector busbar assembly behind a baseboard on or in the wall.

16. The method of claim 10, comprising electrically connecting the connector busbar assembly to respective sets of veil busbars of a plurality of carbon veil heating elements in a plurality of locations.

17. The method of claim 10, comprising causing one or more of the conductive fasteners to penetrate a non-conductive substrate to mechanically fix the conductive heating element and busbar assembly to the substrate.

18. The method of claim 10, further comprising disposing a non-conductive covering over at least a portion of each conductive fastener disposed on and protruding from an outermost surface of the connected heating element and connector busbar assembly.

19. The method of claim 10, further comprising covering the carbon veil heating element and the connector busbar assembly by plaster or cement.

20. The method of claim 19, further comprising disposing a covering over the plaster or cement.

21. The method of claim 10, further comprising positioning a temperature sensor in a location operable to sense heat emitted from the surface and in communication with the controller, wherein the controller is configured to apply electrical current to the connector busbar assembly based upon an input signal from the temperature sensor.
